(19) United States
(12) Patent Application Publication
(10) Pub. No.: US 2024/0289848 A1
(43) Pub. Date: Aug. 29, 2024

(54) DETERMINATION OF HANDHELD WIRELESS DEVICE CONDITION USING MACHINE LEARNED MODEL

(71) Applicant: T-Mobile USA, Inc., Bellevue, WA (US)

(72) Inventors: Nestor Garcia, Atlanta, GA (US); Kristian D. Taylor, Chester, VA (US); Beth Ann Tong, McKinney, TX (US); Ramesh Vemula, Olathe, KS (US); Qianwen Wen, Herndon, VA (US)

(21) Appl. No.: 18/176,247

(22) Filed: Feb. 28, 2023

(51) Int. Cl. G06Q 30/02; G06Q 30/0208; G06T 7/00

(52) U.S. Cl. CPC G06Q 30/0278; G06Q 30/0208; G06T 7/0004; G06T 2207/20081

(57) ABSTRACT

Introduced here is a computer-implemented system for determining current conditions of electronic devices. The system receives an indication from an electronic device that its user is seeking to trade-in the handheld wireless device. The system presents a user interface with a touch screen verification widget for determining operability of a touchscreen of the electronic device. The system receives an identification number and verifies that the electronic device is available for trade-in using the identification number. The system prompts upload of image data depicting the electronic device via a display mechanism. The system inputs the image data to a machine learned model that is trained to determine make, model, and physical condition of electronic devices. The system receives outputs from the machine learned model and determines the current condition of the electronic device based on the outputs, the operability, and the verification.

### BACKGROUND

Mobile phones have become ubiquitous as basic communications tools. They are not only used for calls, but also to access the Internet, send text messages, and capture images. Telecommunications carriers offer flexible options to make mobile phones broadly available to customers. In addition to paying full price or buying a lower-cost, subsidized mobile phone in exchange for signing a multi-year contract, customers can subscribe to pay-to-own equipment installment plans (EIP) along with leasing options.

A customer has an option to resell an existing phone to upgrade to a newer mobile phone. The trade-in value normally depends on a subjective assessment of the mobile phone's condition. For example, a carrier normally asks the customer for a perceived condition of the mobile phone as either “good,” “fair,” or “poor.” The mobile phone is received for processing by the carrier, and a technician performs a manual inspection to assess the mobile phone's condition. The technician may compare the features of the mobile phone against a checklist to determine the mobile phone's trade-in value. The technician can visually inspect the mobile phone for any visible defects such as dents, scuffs, or cracks. However, the technician's ability to inspect a mobile phone is limited by her vision quality and perception. For example, the technician may only be able to see cracks in the mobile device's screen larger than a certain size and/or may only be able to conduct a qualitative assessment of operability of the mobile device's touchscreen.

Thus, methods for assessing a current condition of a mobile phone are unreliable. These methods are also untrustworthy because a customer is inclined to report a higher value while a carrier is motivated to find a lower value. As a result, a customer unfairly receives less credit for trade-in value or the carrier grants too much credit for a compromised device. Hence, a need exists to readily make a reliable, objective, and accurate assessment of a mobile phone's condition.

### BRIEF DESCRIPTION OF THE DRAWINGS

Detailed descriptions of implementations of the present invention will be described and explained through the use of the accompanying drawings.

FIG. 1 is a block diagram that illustrates a system that can determine current conditions of electronic devices.

FIG. 2 is an interaction diagram that illustrates a process for determining a current condition of a computing device.

FIG. 3A is a user interface for beginning a trade-in process.

FIG. 3B is a user interface for determining operability of a touchscreen.

FIG. 3C is a user interface for entering an identification number of a computing device.

FIG. 3D is a user interface for inputting images of a computing device.

FIG. 4 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed systems and methods enable performance of a reliable, objective, and trustworthy determination of a current condition of an electronic device. For example, a dedicated mobile application on a smartphone can collect data indicative of the condition of the electronic device. This data can include images of the electronic device, which are input into a machine learned model that outputs a make, model, and physical condition of the electronic device. The mobile application can also verify an identity of a user of the electronic device and determine whether a touchscreen of the electronic device is operable. The mobile application uses the outputs, verified identity (or lack thereof), and touchscreen operability to determine a current condition of the electronic device. The current condition indicates the ability of the electronic device to be traded in and given to a new user. The mobile application uses the current condition to assign a trade-in or resale value to the electronic device thereby obviating the need for an unreliable and untrustworthy subjective assessment.

The machine learned model is trained to determine make, model and/or physical condition of an electronic device based on image data depicting the electronic device. Physical condition of an electronic device describes whether the electronic device has scratches, scuffs, cracks, or other physical damage or abnormalities based on the make and model of the electronic device. The machine learned model is trained on training data that includes images of other electronic devices. Each image in the training data is labeled with make, model, and/or physical condition of the electronic device shown in the image. The machine learned model can be periodically retrained on new training data of images of electronic devices that are new makes/models and/or show different physical damage representing the physical condition of the electronic device.

By using a machine learned model to determine trade-in value for an electronic device, the challenges of obtaining trustworthy data to measure the current condition of an electronic device are eliminated. That is, the disclosed embodiments use the machine learned model for immutable and trustworthy outputs that can be used to determine current conditions of electronic devices. The disclosed technology can be used to determine the current condition of any Internet-of-Things devices or anything else where the condition of an object dictates its value.

Various embodiments of the disclosed systems and methods are described. The following description provides specific details for a thorough understanding and an enabling description of these embodiments. One skilled in the art will understand, however, that the invention can be practiced without many of these details. Additionally, some well-known structures or functions may not be shown or described in detail for the sake of brevity. The terminology used in the description presented below is intended to be interpreted in its broadest reasonable manner, even though it is being used in conjunction with a detailed description of certain specific embodiments of the invention.

Although not required, embodiments are described below in the general context of computer-executable instructions, such as routines executed by a general-purpose data processing device, e.g., a networked server computer, mobile device, or personal computer. Those skilled in the relevant art will appreciate that the invention can be practiced with other communications, data processing, or computer system configurations, including: Internet appliances, handheld devices, wearable computers, all manner of cellular or mobile phones, multi-processor systems, microprocessor-based or programmable consumer electronics, set-top boxes, network PCs, mini-computers, mainframe computers, media players and the like. Indeed, the terms “computer,” “server,” and the like are generally used interchangeably herein and refer to any of the above devices and systems, as well as any data processor.

While aspects of the disclosed embodiments, such as certain functions, can be performed exclusively or primarily on a single device, some embodiments can also be practiced in distributed environments where functions or modules are shared among disparate processing devices, which are linked through a communications network, such as a local area network (LAN), wide area network (WAN), a wireless telecommunications network, or the Internet. In a distributed computing environment, program modules can be located in both local and remote memory storage devices.

Aspects of the invention can be stored or distributed on tangible computer-readable media, including magnetically or optically readable computer discs, hardwired or preprogrammed chips (e.g., EEPROM semiconductor chips), nanotechnology memory, biological memory, or other data storage media. In some embodiments, computer-implemented instructions, data structures, screen displays, and other data under aspects of the invention can be distributed over the Internet or over other networks (including wireless networks), on a propagated signal on a propagation medium (e.g., an electromagnetic wave(s), a sound wave) over a period of time, or they can be provided on any analog or digital network (packet-switched, circuit-switched, or other scheme).

### System Overview

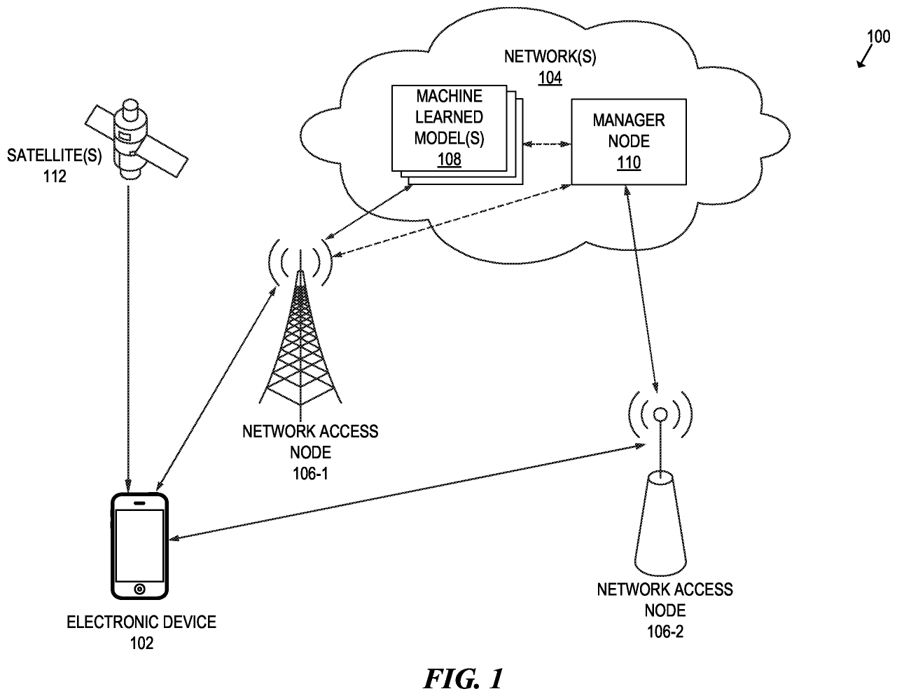

FIG. 1 is a block diagram that illustrates a system that can determine current conditions of electronic devices. The system 100 includes an electronic device 102 that is communicatively coupled to one or more networks 104 via network access nodes 106-1 and 106-2 (referred to collectively as network access nodes 106).

The electronic device 102 is any type of electronic device that can communicate wirelessly with a network node and/or with another electronic device in a cellular, computer, and/or mobile communications system. Examples of the electronic device 102 includes smartphones (e.g., APPLE IPHONE, SAMSUNG GALAXY), tablet computers (e.g., APPLE IPAD, SAMSUNG NOTE, AMAZON FIRE, MICROSOFT SURFACE), wireless devices capable of machine-to-machine (M2M) communication, wearable electronic devices, movable Internet of Things devices (IoT devices), and any other handheld device that is capable of accessing the network(s) 104. Although only one electronic device 102 is illustrated in FIG. 1, the disclosed embodiments can include any number of electronic devices.

The electronic device 102 can store and transmit (e.g., internally and/or with other electronic devices over a network) code (composed of software instructions) and data using machine-readable media, such as non-transitory machine-readable media (e.g., machine-readable storage media such as magnetic disks, optical disks, read-only memory (ROM), flash memory devices, and phase change memory) and transitory machine-readable transmission media (e.g., electrical, optical, acoustical, or other forms of propagated signals, such as carrier waves or infrared signals).

The electronic device 102 can include hardware such as one or more processors coupled to sensors and a non-transitory machine-readable media to store code and/or sensor data, user input/output (I/O) devices (e.g., a keyboard, a touchscreen, and/or a display), and network connections (e.g., an antenna) to transmit code and/or data using propagating signals. The coupling of the processor(s) and other components is typically through one or more busses and bridges (also referred to as bus controllers). Thus, a non-transitory machine-readable medium of a given electronic device typically stores instructions for execution on a processor(s) of that electronic device. One or more parts of an embodiment of the present disclosure can be implemented using different combinations of software, firmware, and/or hardware.

The network access nodes 106 can be any type of radio network node that can communicate with a wireless device (e.g., electronic device 102) and/or with another network node. The network access nodes 206 can be a network device or apparatus. Examples of network access nodes include a base station (e.g., network access node 106-1), an access point (e.g., network access node 106-2), or any other type of network node such as a network controller, radio network controller (RNC), base station controller (BSC), a relay, transmission points, and the like.

The system 100 depicts different types of wireless access nodes 106 to illustrate that the electronic device 102 can access different types of networks through different types of network access nodes. For example, a base station (e.g., the network access node 106-1) can provide access to a cellular telecommunications system of the network(s) 104. An access point (e.g., the network access node 106-2) is a transceiver that provides access to a computer system of the network(s) 104.

The network(s) 104 can include any combination of private, public, wired, or wireless systems such as a cellular network, a computer network, the Internet, and the like. Any data communicated over the network(s) 104 can be encrypted or unencrypted at various locations or along different portions of the networks. Examples of wireless systems include Wideband Code Division Multiple Access (WCDMA), High Speed Packet Access (HSPA), Wi-Fi, Wireless Local Area Network (WLAN), and Global System for Mobile Communications (GSM), GSM Enhanced Data Rates for Global Evolution (EDGE) Radio Access Network (GERAN), 4G or 5G wireless wide area networks (WWAN), and other systems that can also benefit from exploiting the scope of this disclosure.

The system 100 includes a machine learned model(s) 108 that output data used to determine current condition of electronic devices 102. A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the machine learned model(s) 108 can be a neural network(s) with multiple input nodes that receive images. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the input that, once the model is trained, can be used as to determine current condition of electronic devices 102. In some implementations, such neural networks, known as deep neural networks, can have multiple layers of intermediate nodes with different configurations, can be a combination of models that receive different parts of the input and/or input from other parts of the deep neural network, or are convolutions-partially using output from previous iterations of applying the model as further input to produce results for the current input.

The machine learned model(s) 108 can be trained with supervised learning, where the training data includes a set of images as input, each labeled with a desired output. For instance, each image in the set of training data can be labeled with the make of the electronic device 102 depicted in the image, the model of the electronic device 102 depicted in the image, and/or a numerical value that represents a physical condition of the electronic device 102 depicted in the image. For example, an image of an electronic device 102 that does not have cracks, scratches, or scuffs may be labeled with 100%, whereas an image of an electronic device 102 where most of the screen is damaged would be labeled with 10%. In some embodiments, the images in the set of training data may include subsets of images, where each subset shows different views of the same electronic device 102. For example, a first image in a subset may depict a touchscreen of an electronic device 102 and may be labeled with 90% due to having minor damage to the touchscreen. A second image in the subset may depict a back side of the same electronic device 102 and may be labeled with 80% due to having a few scuff marks.

The training data can be provided to the model for training. Output from the model for an image can be compared to the desired output that the image is labeled with. Based on the comparison, the model can be modified, such as by changing weights between nodes of the neural network or parameters of the functions used at each node in the neural network (e.g., applying a loss function). After applying each of the images in the training data and modifying the model in this manner, the model can be trained to evaluate new images of electronic devices 102.

The system 100 includes a manager node 110 that can determine current conditions of electronic devices 102 using the machine learned model(s) 108. In some embodiments, the manager node 110 can include any number of server computers communicatively coupled to the electronic device 102 via the network access nodes 106. The manager node 110 can include combinations of hardware and/or software to process condition data, perform functions, communicate over the network(s) 104, etc. For example, server computers of the manager node 110 can include a processor, memory or storage, a transceiver, a display, operating system and application software, and the like. Other components, hardware, and/or software included in the system 100 that are well known to persons skilled in the art are not shown or discussed herein for brevity. Moreover, although shown as being included in the network(s) 104, the manager node 110 can be located anywhere in the system 100 to implement the disclosed technology.

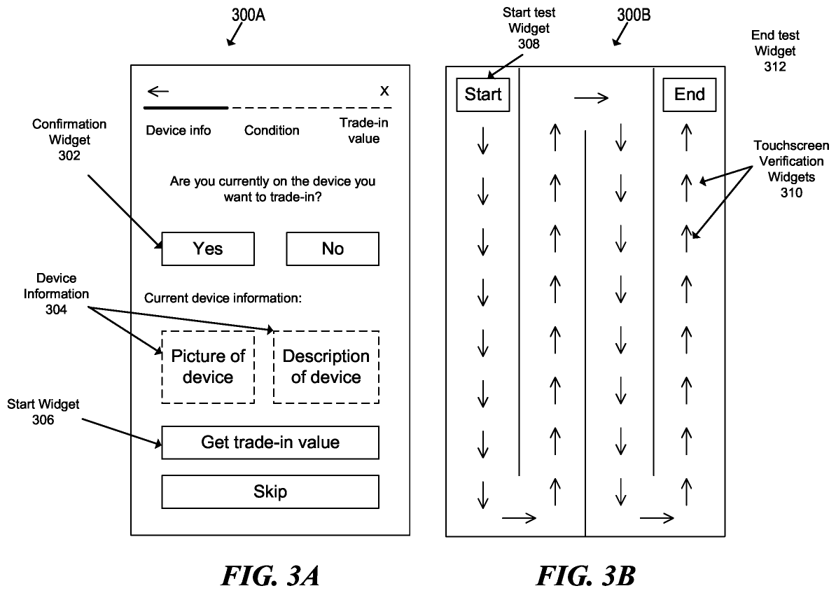

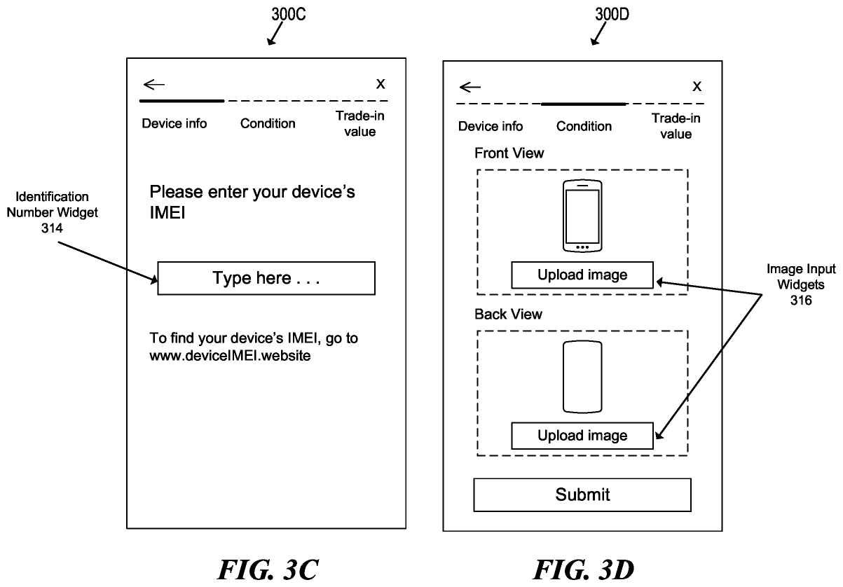

The manager node 110 can determine the current trade-in value of the electronic device 102. The manager node 110 can transmit graphical user interfaces (GUIs) and receive input via widgets presented at the GUIs from the electronic device 102. The widgets are interactive elements such as buttons, sliders, checkboxes, and the like and are further described in relation to FIGS. 3A-D. The manager node can use the GUIs to determine that a user wants to trade-in the electronic device 102, determine operability of a touchscreen of the electronic device 102, verify the user based on an identification number of the electronic device 102.

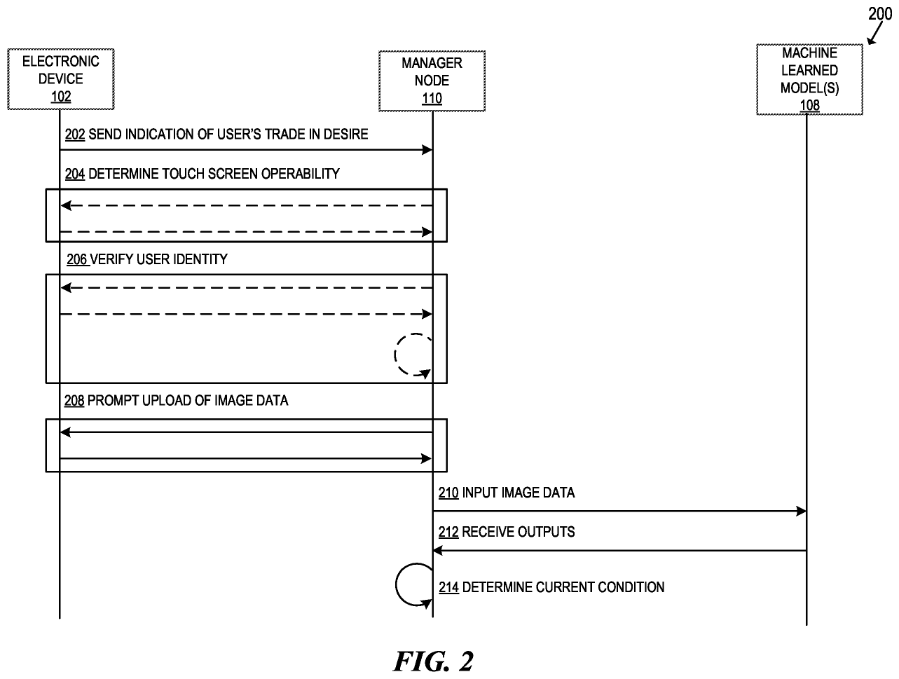

FIG. 2 is an interaction diagram 200 that illustrates a process for determining a current condition of a computing device. The interactions shown in FIG. 2 occur between the electronic device 102, the manager node 110, and the machine learning model(s) 108. In some embodiments, the interactions may occur between additional or alternate components to those shown in FIG. 2.

The electronic device 102 may present a graphical user interface (GUI) that includes one or more widgets that a user can interact with to indicate that she would like to trade-in the electronic device 102. In some embodiments, the user may indicate, via the GUI, a desire to trade-in another electronic device 102 than the one presenting the GUI. The electronic device 102 sends 202, to the manager node 110, an indication of the user's desire to trade-in the electronic device 102.

In some embodiments, the manager node 110 determines 204 operability of the electronic device's 102 touch screen. The manager node 110 transmits, for display at the electronic device 102, a GUI including one or more widgets that a user may interact with at the electronic device 102 to confirm that corresponding portions of the touchscreen are operable. For example, the GUI can include a set of widgets evenly dispersed on the touchscreen, and the manager node 110 can associate each widget with an identifier of the portion of the touchscreen that displays the widget. The set of widgets may include one or more of buttons, sliders, checkboxes, and the like.

When a user interacts with a widget (e.g., by touching an image representing the widget), the manager node 110 receives an indication of the interaction from the electronic device 102 and stores the indication in association with the identifier of the corresponding portion of the touchscreen displaying the widget. If the manager node 110 receives an indication for each widget in the set, the manager node 110 determines that the touchscreen of the electronic device 102 is operable. If the manager node 110 does not receive an indication for one or more widgets within a predetermined time period (e.g., 5 minutes from the beginning of presentation of the GUI), the manager node 110 determines that the portions of the touchscreen corresponding to the one or more widgets are not operable. In another embodiment, the manager node presents one of the set of widgets as an “end” widget (e.g., indicating to the user to interact with the widget when she has finished interacting with the rest of the widgets in the set). Once the manager node 110 receives an indication associated with the end widget, the manager node 110 determines that portions of the touchscreen corresponding to widgets that manager node 110 did not receive indications for are not operable. The manager node 110 stores the indications in relation to the widgets and associated portions of the touchscreen.

In some embodiments, the manager node 110 verifies 206 the user of the electronic device's identity. The manager node 110 prompts inputs of an identification number of the electronic device 102 via a GUI. The identification number is a number unique to each electronic device 102 and can be used to track electronic devices 102 that may have been stolen from or lost by a user. The identification number may be an International Mobile Equipment Identity (IMEI) that is a unique number used to electronic devices 102 (such as GSM, WCDMA, and Integrated Digital Enhanced Network (iDEN) mobile phones and some satellite phones). Most electronic devices 102 only have one IMEI number, but some dual Subscriber Identity Module (SIM) phones have two IMEI numbers.

In response to receiving an identification number via the GUI, the manager node 110 compares the received identification number to an identification number stored in relation to an identifier of the user of the electronic device 102. If the identification numbers match, the manager node 110 determines that the electronic device 102 is available to be traded in. If the identification numbers do not match, the manager node 110 can establish communication with or send a notification to an external operator that the electronic device 110 may be compromised and/or send a notification for display at the electronic device 102 that the user needs to contact an external operator to move forward with trading in the electronic device 102.

The manager node 110 prompts 408 upload of image data of the electronic device 102 via the GUI. In some embodiments, the image data may be one or more images of another electronic device 102 that the user wants to trade-in. The manager node 110 receives the image data from the electronic device 102. The image data may be one or more images and may depict different views of the electronic device 102. For example, the images may show each side of the electronic device 102 or may only depict a screen (or touchscreen) of the electronic device 102.

The manager node 110 inputs 410 the image data to the machine learned model(s) 108. The manager node 110 receives 412 outputs from the machine learned model(s) 108. The data may indicate the make, model, and physical condition of the electronic device 102. In some embodiments, the machine learned model(s) 108 outputs additional data that indicates other characteristics of the electronic device 102, such as type (e.g., mobile phone, laptop, tablet, etc.) or color. The manager node 110 determines 214 a current condition of the electronic device 102 based on the outputs, the verification, and/or operability of the touchscreen. For instance, the manager node 110 may compare each of the numerical value to a series of thresholds to determine the current condition of the electronic device 102. For example, the thresholds may define numerical ranges for “like new,” “good,” “poor,” and “bad” conditions. The manager node 110 can augment the current condition based on the operability of the touchscreen and the verification. For instance, the manager node 110 can multiply the numerical value by a percentage of the touchscreen that is operable before determining the current condition based on the thresholds. The manager node 110 can also determine that the current condition of the electronic device 102 is “unable to trade-in” if the verification failed. The manager node 110 can determine whether the electronic device 102 a trade-in value for the electronic device 102 based on the current condition. The manager node 110 stores the current condition and the trade-in value in association with the image data, the outputs, and an identifier of the electronic device 102. The manager node 120 may also send an indication of the current condition and/or trade-in value for display at the electronic device 102.

The process 200 may include additional or alternative interactions to those shown in FIG. 2. For example, in some embodiments, the manager node 110 receives input from an external operator regarding the determined current condition, such as an actual trade-in value of the electronic device 102 based on the current condition or the actual make, model and physical condition observed by the external operator. For example, the external operator can determine, upon observing the actual electronic device 102, that the electronic device 102 has a large scratch that was blocked by a glare in the image data. The manager node 110 labels the image data input to the machine learned model(s) 108 with the outputs and the inputs from the external operator and retrains the machine learned model(s) 108 using the labeled image data. In some embodiments, the images may also be labeled with the perspective/view (e.g., side, top, back) of the electronic device 102 shown. This training and retraining of the machine learned model(s) 108 allows the machine learned model(s) 108 to adjust its evaluation of image data and improve its accuracy in outputting make, model, and physical condition (and/or other characteristics) of the electronic device 102.

In some embodiments, the manager node 110 determines operability of the touchscreen based on a pattern of touch inputs received via widgets displayed at the GUI. For instance, the manager node 110 causes the electronic device 102 to administer a test via the widgets such that the user may input a pattern of touch inputs via the widgets. The manager node 110 determines that portions of the touchscreen corresponding to the pattern are operable. In some embodiments, the manager node compares the numerical value to a damage threshold. If the numerical value is greater than the damage threshold, the manager node 110 determines that the electronic device 102 is not transferable to another user (e.g., unable to be traded in). In some embodiments, the manager node 102 adds the current condition of the electronic device 102 to an electronic ledger associated with the particular electronic device 102. The electronic ledger may be used by the manager node 110 to track the condition of the particular electronic device 102 over time and various users.

FIG. 3A is a user interface 300A for beginning a trade-in process. The user interface 300A may be a GUI transmitted by the manager node 110 and includes widgets that a user may interact with via a touchscreen (or other display mechanism) of the electronic device 110 to begin a process for trading in the electronic device 102. The user interface 300A includes a confirmation widget 302, which, in this embodiment, is a button that the user can interact with to indicate the user interface 300A is being presented on the electronic device 102 that she wants to trade-in. The user interface 300A may also include device information 304 about the electronic device 102, such as a picture of a generic version of the electronic device 102 and a textual description of the generic version of the electronic device 102, and a start widget 306, which may be a button the user can interact with to begin the trade-in process for the electronic device 102.

FIG. 3B is a user interface for determining operability of a touchscreen. The user interface 300B can be a GUI transmitted from the manager node 110 for display at the electronic device 102. The user interface 300B includes widgets that a user can interact with to assess the operability of a touchscreen of the electronic device 102. For example, the widgets can be dispersed across the touchscreen such that the user would come in physical contact with the entire touchscreen upon interacting with each of the widgets.

In the embodiment shown in FIG. 3B, the user interface 300B includes a start test widget 308, which the user can interact with to begin testing the operability of the touchscreen. Once the test has started, the user can interact with each of the touchscreen verification widgets 310 before ending the test by interacting with the end test widget 312. The manager node 110 receives an indication from the electronic device 102 for each touchscreen verification widget that the user interacted with and determines that an associated portion of the touchscreen that presents the respective touchscreen verification widget 310 is operating properly. For any touchscreen verification widget 310 from which the manager node 110 does not receive an indication of an interaction, the manager node 110 determines that the associated portion of the touchscreen is not operating. The manager node 110 can determine that the portions of the touchscreen associated with the start test widget 308 and the end test widget 312 are not operable in response to receiving indications related to other touchscreen verification widgets 310 within a time period of the user interface 300B being displayed. The manager node 110 stores information describing the operability of the touchscreen for use in determining a current condition of the electronic device 110.

FIG. 3C is a user interface 300C for entering an identification number of a computing device. The user interface 300C may be a GUI transmitted by the manager node 110 for display at the electronic device 102. In the embodiment shown in FIG. 3C, the user interface 300C includes an identification number widget 314, which can be a text box into which a user can input the identification number of the electronic device 102 to for verification of the user's identity in relation to the electronic device 102. The user interface 300C can also include information about how to find the identification number of the electronic device 102.

FIG. 3D is a user interface 300D for inputting images of a computing device. The user interface 300D may be a GUI sent by the manager node 110 for display at the electronic device 102 and can include image input widgets 316 that the user can interact with to upload images (or other image data, such as video data) of the electronic device 102. In embodiments where the user is training in another electronic device 102 (e.g., not the electronic device 102 displaying the user interface 300D), the user can interact with the image input widgets 316 to capture images (or other image data, such as video data) of the other electronic device 102. The user interface 300D can include multiple image input widgets 316 each associated with a different perspective/view (e.g., front, side, back, etc.) of the electronic device 102 that the image input should depict.

### Computer System

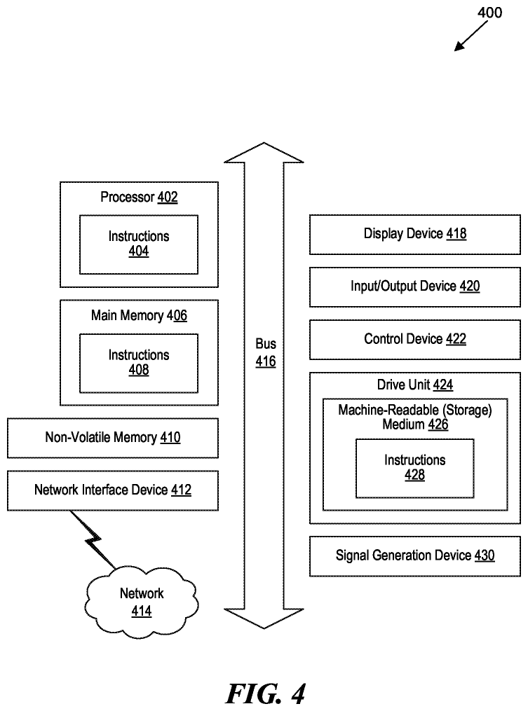

FIG. 4 is a block diagram illustrating an example of a processing system 400 in which at least some operations described herein can be implemented. For example, components of the processing system 400 may be hosted on a computing device that includes the system 100.

The processing system 400 may include a processor 402, main memory 406, non-volatile memory 410, network adapter 412, video display 418, input/output device 420, control device 422 (e.g., a keyboard or pointing device), drive unit 424 including a storage medium 426, and signal generation device 430 that are communicatively connected to a bus 416. The bus 416 is illustrated as an abstraction that represents one or more physical buses or point-to-point connections that are connected by appropriate bridges, adapters, or controllers. The bus 416, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), inter-integrated circuit (I2C) bus, or an Institute of Electrical and Electronics Engineers (IEEE) standard 1394 bus (also referred to as “Firewire”).

While the main memory 406, non-volatile memory 410, and storage medium 426 are shown to be a single medium, the terms “machine-readable medium” and “storage medium” should be taken to include a single medium or multiple media (e.g., a centralized/distributed database and/or associated caches and servers) that store one or more sets of instructions 428. The terms “machine-readable medium” and “storage medium” shall also be taken to include any medium that is capable of storing, encoding, or carrying a set of instructions for execution by the processing system 400.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in a computing device. When read and executed by the processors 402, the instruction(s) cause the processing system 400 to perform operations to execute elements involving the various aspects of the present disclosure.

Further examples of machine- and computer-readable media include recordable-type media, such as volatile memory devices and non-volatile memory devices 510, removable disks, hard disk drives, and optical disks (e.g., Compact Disk Read-Only Memory (CD-ROMS) and Digital Versatile Disks (DVDs)), and transmission-type media, such as digital and analog communication links.

The network adapter 412 enables the processing system 400 to mediate data in a network 414 with an entity that is external to the processing system 400 through any communication protocol supported by the processing system 400 and the external entity. The network adapter 412 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

### REMARKS

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. A method for determining a current condition of a handheld wireless device configured to communicate data over a wireless telecommunications network, the method comprising:
receiving a first indication from the handheld wireless device that a user of the handheld wireless device seeks to trade-in the handheld wireless device;
causing display, at the handheld wireless device via a display mechanism, a touch screen verification widget;
receiving a second indication that a touch screen of the handheld wireless device is operable based on a pattern of touch inputs to the touch screen,
wherein the pattern of touch inputs is input by the user in response to a test administered by the touch screen verification widget;
prompting, via the display mechanism, input of an identification number of the handheld wireless device;
in response to receiving the identification number, verifying that the handheld wireless device is available for trade-in or verifying an identity of the user of the handheld wireless device based on the identification number;
prompting, via the display mechanism, upload of image data depicting the handheld wireless device;
inputting the image data to a machine learned model, wherein:
the machine learned model is trained on a set of training data to determine make, model, and physical condition of handheld wireless devices; and
the set of training data includes images of handheld wireless devices, each image labeled with the make of a respective handheld wireless device, the model of the respective handheld wireless device, and a numerical value representative of the physical condition of the respective handheld wireless device;
receiving outputs from the machine learned model,
wherein the outputs represent the make, model, and physical condition of the handheld wireless device; and
determining the current condition of the handheld wireless device based on the second indication that the touch screen of the handheld wireless device is operable, the verification based on the identification number, and the outputs of the machine learned model.

2. The method of claim 1, further comprising:
in response to determining the numerical value is greater than a damage threshold, determining that the handheld wireless device is not transferable to a second user.

3. The method of claim 1, further comprising:
adding, to an electronic ledger associated with the handheld wireless device, the current condition at a current time and date.

4. The method of claim 1, wherein the image data is one or more of images and/or videos.

5. The method of claim 1, wherein the identification number is an International Mobile Equipment Identity (IMEI).

6. The method of claim 1, further comprising:
in response to not verifying the identity of the user, establishing communication with an electronic device of an external operator.

7. The method of claim 1, further comprising:
transmitting, for display via the display mechanism, a notification of the current condition of the handheld wireless device.

8. A method for determining a current condition of an electronic device, the method comprising:
training a machine learned model to determine condition of electronic devices by inputting a set of images of electronic devices, each image labeled with a numerical value representative of physical condition of a respective electronic device;
prompting, via a display mechanism, upload of image data depicting the current condition of the electronic device;
inputting the image data to the machine learned model;
receiving, as output from the machine learned model, a numerical value representative of the physical condition of the electronic device; and
determining the current condition of the electronic device based on the numerical value.

9. The method of claim 8, further comprising:
in response to determining the numerical value is greater than a damage threshold, determining that the electronic device is not transferable to a second user.

10. The method of claim 8, further comprising:
adding, to an electronic ledger associated with the electronic device, the current condition at a current time and date.

11. The method of claim 8, wherein the image data is one or more of images and/or videos.

12. The method of claim 8, further comprising:
in response to not verifying an identity of a user of the electronic device, establishing communication with a second electronic device of an external operator.

13. The method of claim 8, further comprising:
transmitting, for display via the display mechanism, a notification of the current condition of the electronic device.

14. A system comprising:
a processor; and
a non-transitory computer-readable storage medium storing instructions that when executed cause the processor to perform actions comprising:
receiving a first indication from a handheld wireless device that a user of the handheld wireless device wants to trade in the handheld wireless device;
transmitting, to the handheld wireless device for display via display mechanism, a touch screen verification widget;
receiving a second indication that a touch screen of the handheld wireless device is operable in response to the transmission;
prompting, via the display mechanism, input of an identification number of the handheld wireless device;
in response to receiving the identification number, verifying an identity of the user of the handheld wireless device based on the identification number;
prompting, via the display mechanism, upload of image data depicting the handheld wireless device;
inputting the image data to a machine learned model, wherein:
the machine learned model is trained on a set of training data to determine make, model, and physical condition of handheld wireless devices; and
the set of training data includes images of handheld wireless devices, each image labeled with the make of a respective handheld wireless device, the model of the respective handheld wireless device, and a numerical value representative of the physical condition of the respective handheld wireless device;
receiving outputs from the machine learned model,
wherein the outputs represent the make, model, and physical condition of the handheld wireless device; and
determining a current condition of the handheld wireless device based on the second indication, the verified identity, and the outputs.

15. The system of claim 14, the actions further comprising:
in response to determining the numerical value is greater than a damage threshold, determining that the handheld wireless device is not transferable to a second user.

16. The system of claim 14, the actions further comprising:
adding, to an electronic ledger associated with the handheld wireless device, the current condition at a current time and date.

17. The system of claim 14, wherein the image data is one or more of images and/or videos.

18. The system of claim 14, wherein the identification number is an International Mobile Equipment Identity (IMEI).

19. The system of claim 14, the actions further comprising:
in response to not verifying the identity of the user, establishing communication with an electronic device of an external operator.

20. The system of claim 14, the actions further comprising:
transmitting, for display via the display mechanism, a notification of the current condition of the handheld wireless device.
